(19) United States
(12) Patent Application Publication
(10) Pub. No.: US 2005/0142035 A1
(43) Pub. Date: Jun. 30, 2005

(54) Micro-discharge sensor system

(76) Inventors: Ulrich Bonne, Hopkins, MN (US); Stephen R. Shiffer, Pearl City, IL (US); Brian C. Krafthefer, Stillwater, MN (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/915,577

(22) Filed: Aug. 10, 2004

Related U.S. Application Data
(63) Continuation-in-part of application No. 10/749,863, filed on Dec. 31, 2003.

(51) Int. Cl. G01N 21/00

(52) U.S. Cl. 422/82.05

(57) ABSTRACT

A micro plasma sensor system having a glow discharge gap formed by electrodes. A fluid to be sensed may be brought into the vicinity of a discharge at the gap. Light from the discharge may be coupled to a spectrum analyzer and/or processor for determining properties of the fluid. A coupling may include a waveguide proximate to the discharge gap. Window cleanliness and electrode electrical isolation may be maintained by the discharge. The optical analyzer may have filters for one or more optical channels to detectors. The detectors may output electrical signals to be processed. The electrodes may be parallel to each other with a light waveguide between them. Or the electrodes may be concentric forming an annular discharge gap. The light waveguide may likewise be concentric to one or more electrodes. The waveguide may be one or more optical fibers, or tubular.

The present application claims priority as a continuation-in-part to co-pending U.S. Nonprovisional application No. 10/749,863, filed Dec. 31, 2003, by Ulrich et al., and entitled “MICRO-PLASMA SENSOR SYSTEM”, which is incorporated herein by reference.

### BACKGROUND

The present invention pertains to detection of fluids. Particularly, the invention pertains to plasma structures, and more particularly to the application of the structures as sensors for the identification and quantification of fluid components. The term “fluid” may be used as a generic term that includes gases and liquids as species. For instance, air, gas, water and oil are fluids.

Aspects of structures and processes related to fluid analyzers may be disclosed in U.S. Pat. No. 6,393,894 B1, issued May 28, 2002, to Ulrich Bonne et al., and entitled “Gas Sensor with Phased Heaters for Increased Sensitivity,” which is incorporated herein by reference.

Related art fluid composition analyzers may be selective and sensitive but lack the capability to identify the one or more components of a sample mixture with unknown components, besides being generally bulky and costly. The state-of-the-art combination analyzers GC-GC and GC-MS (gas chromatograph—mass spectrometer) approach the desirable combination of selectivity, sensitivity and smartness, yet are bulky, costly, slow and unsuitable for battery-powered applications. In GC-AED (gas chromatograph—atomic emission detector), the AED alone uses more than 100 watts, uses water cooling, has greater than 10 MHz microwave discharges and are costly.

Micro gas chromatography (μGC) detectors should be fast responding (<1 ms), sensitive but not selective to specific compounds, of simple construction and low-cost, compact, and low-power (˜mW). Presently available or conceived μGC detectors are either not very sensitive, such as thermal conductivity sensors (>10 to 100 ppm of analyte); too selective to specific compounds such as fluorescence and electron-capture detectors; relatively high-cost such as the typical price tags in year 2003 of about $600, $3000 and upwards for many GC detectors; prone to drift due to soiled optics as micro-discharge devices (MDDs) monitored via spectral analysis; or relatively high-power such as the AEDs (atomic emission detectors) which consume over 100 W.

Related art NOₓ (and to an extent NH₃, SOₓ, COₓ, O₂, VOC, and the like) sensors to monitor and/or control such emissions from (internal and external) combustion processes are not suited for use in unsupervised, stationary or automotive combustion systems. They are either too costly (chemiluminescence (CL) and even multi-layered ZrO₂ sensors), too bulky (chemiluminescence and IR absorption if the detection limit is to be near 5 ppm), too fragile (CL and IR long-path cell) or not stable enough (SnO₂/WO₃ and wet-electrochemical sensors) or too costly especially for automotive applications. Other known problems of optical sensors is their high maintenance cost, as needed to keep the optics clean, and the short life of the electrical contacts to any electrical-powered sensor exposed to harsh combustion exhaust conditions

Related art optical gas sensors (NO, CO, NH₃, SO₂, CH₄, . . . , CWA) based on spectral analysis of glow discharge emission are not suited for compact, low-cost, wide-wavelength-range packaged systems because they lack a rugged, low-cost and compact multi-channel analyzer. They are either too costly and bulky (e.g., FTIR or conventional dispersive spectrometers, or even new, compact palm-top-size spectrometers), too fragile (spectrometers), not transmissive enough (narrow band-pass filters need fairly good collimation of light to avoid band broadening, i.e., need low aperture operation resulting in low-light transmission) or not versatile enough (small number of channels with individual, narrow band-pass filters). Also, a problem of these optical sensors is their high maintenance cost, such as keeping their optics clean.

### SUMMARY

The invention may be a sensor system having a discharge gap formed by electrodes. A fluid to be sensed may enter the vicinity of a discharge at the gap. An optical coupling may include a waveguide proximate to the discharge gap. Cleanliness of the optical coupling and one or more electrodes may be maintained by the discharge. A processor may be coupled to the waveguide. The electrodes and waveguide may have various configurations and arrangements.

### BRIEF DESCRIPTION OF THE DRAWING

FIG. 1 shows a micro discharge device optically coupled to an optical multi-channel analyzer based on light inputs through interference filters;

FIG. 2 is a close view of a discharge gap to optical fiber interface;

FIG. 3 shows a discharge gap housing attached to an exhaust pipe;

FIG. 4 shows a micro discharge device optically coupled to an optical, single-channel, wavelength-modulated analyzer based on a scanning Fabry-Perot filter;

FIG. 5 is a close view of the Fabry-Perot type analyzer;

FIG. 6 shows a micro discharge device optically coupled to a spectrometer;

FIG. 7 is a graph of the relative intensity versus wavelength for a spectral emission of a glow discharge with a mixture of NO in N₂;

FIG. 8 is a table of angular sensitivity data for materials of various refractive indexes;

FIG. 9 is a table of Fabry-Perot filter design parameters for wavelength modulation in gas sensing;

FIG. 10 is a graph of a wavelength scan of a Fabry-Perot filter;

FIG. 11 is a sensor system having a silica chip to support the micro discharge electrodes;

FIG. 12 is a sensor system having no silica chip to support the micro discharge electrodes;

FIG. 13 shows a sensor situated in a spark-plug-like package;

FIGS. 14 and 14a are cross-section diagrams of sensors revealing electrode enclosures;

FIG. 15 is a cutaway of the a sensor showing overlapping edges of the electrodes;

FIG. 16 shows a sensor having a concentric electrode relative to a light waveguide;

FIG. 17 is a cross-section view of concentric electrodes forming an annular discharge gap;

FIGS. 18a and 18b are top views of an optical fiber and a pair of electrodes separated by a number of optical fibers;

FIG. 19a is a side cross-section and top view of two electrodes separated by an optical fiber; and

FIG. 19b is a side cross-section and top view of two concentric electrodes separated by a light waveguide.

### DESCRIPTION

The present optical spectral/molecular emission-based NO (and other chemicals) sensor system may be a low power, low-mass and compact (the emissive glow discharge plasma of each element may be 10 to 100 microns in diameter). The system may have its plasma operate at about 1100 degrees C. Also, the system may be low-cost, rugged (no precision optical alignments needed) and maintain operational stability various kinds of environments. With adequate air filtering, sensor system operation may occur without noble gas purging, such as for exhaust gas composition measurements, along with high temperature plasma self-cleaning, signal processing and advantageous low-cost, compact and rugged packaging.

MDD may be used for optical transmission surface cleaning and for maintaining electrode isolation in an MDD detector application; that is, the same plasma discharge may be used to keep the observation window clean, by plasma-etching away any combustion-product deposits such as condensable tars and carbon-soot. The same or a similar glow discharge may maintain cleanliness and (more importantly) the required electrical isolation of the soot-sensor electrodes of soot sensors. One may co-locate a spectral-emissive and a soot sensor in one package. In other words, it is compatible and easy to integrate with soot sensor systems.

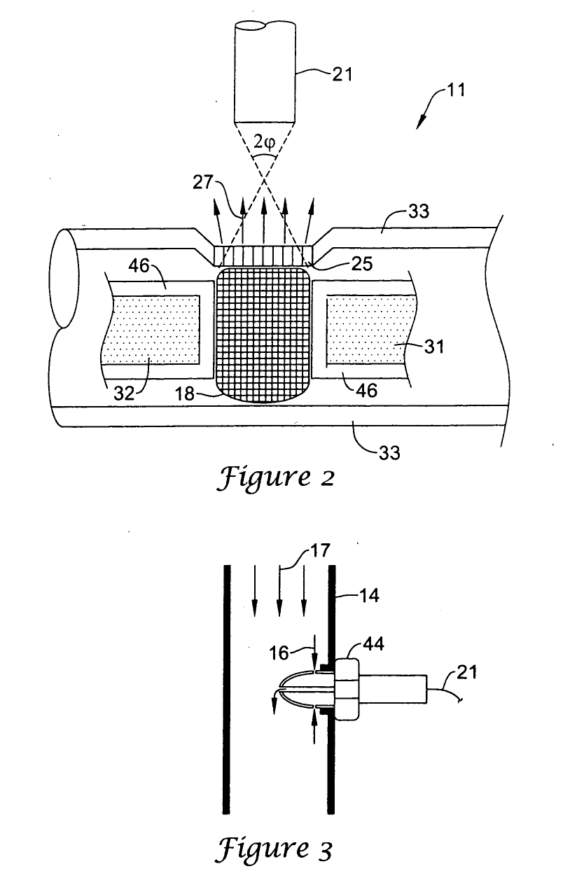

The silica chip may be eliminated and the discharge may be operated between two free-standing electrodes. The same plasma discharge may maintain the required electrical insulation of the non-grounded micro-discharge electrode (magnified view of one example electrode tip in FIG. 2), or achieve such insulation by periodic power-cleaning cycles, which may or may not cause a pause in the measurement and the self-check cycle.

With little power, an electrostatic field across the impactor “baffles” or between the “fins” of the cyclone element can improve the capture and retention of the smaller particles. Housing with louvers (and cyclonic and impactor particle separators) may be less costly than the sensor system frit. Integrated particle removal via cyclone and impactor plate may occur with low Δp to sample gas flow (FIG. 14).

Smart positioning between the end of the optical fiber and the photodiode may be used to detect optical fiber light components of small angles, as required by the chosen bandpass filter width.

The present system may be more compact, rugged and lower cost than chemiluminescence-based sensor systems. It may be more stable than metal-oxide or catalyst-based and conventional optical sensor systems and less energy consuming than ZrO2-based sensor systems. The present system may be more tolerant to temperature change than other sensor systems, and more manufacturable than multi-layer ZrO2, metal oxide or catalyst based sensor systems.

The present system may be lower cost than previous MDD-based NOₓ sensor systems. It may permit observation of NO spectral emissions in the IR. Also, it may allow co-planar design with one MDD as source and another as detector.

Concerns about water condensation may be obviated with removal or preferably made harmless via sensor heating. Another sensor may be packaged into the same housing of the system to reduce cost, total bulkiness and incorporate plasma-cleaning synergies.

Spectral analysis of the MDD emission may rely on a scanning, narrow band-pass, MEMS Fabry-Perot (FP) filter, i.e., it is compact, versatile (having many channels), highly effective light intensity (despite the high mirror-etalon reflectivity if many (100 to 1000) MDDs are operated in parallel) and low-maintenance because the FP-filter operates in a sealed environment, and the only other optical surface exposed to sample gas is self-cleaned by the MDD.

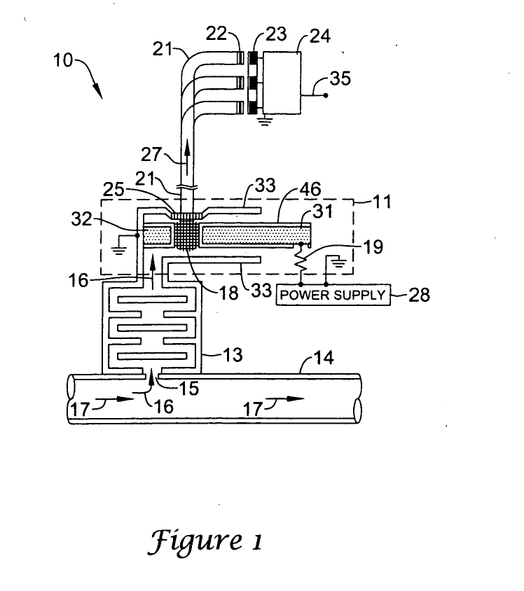

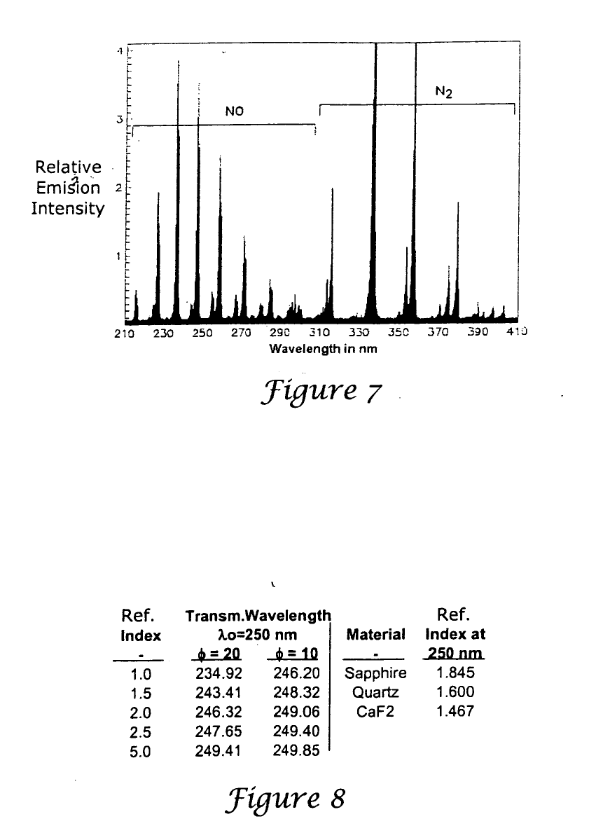

A micro discharge device (MDD) 11 is shown in systems 10, 20 and 30 of FIGS. 1, 4 and 6, respectively. Device 11 may have one electrode 31 and another electrode 32 with ends facing each other to form a gap for providing a micro glow discharge 18. The gap may be enclosed in a glass tube or hollow pipe 33. Device 11 may have a soot electrode that may be kept clean of soot build-up. The glow of device 11 may have a UV/visible spectrum as shown in a graph of FIG. 7. That graph shows relative intensity versus wavelength in nm for a spectral emission of a glow discharge using 22.9 ppm of NO in N₂ in an environment of 700 Torr. To date, noble gases (N₂, Ar, He) have been used to study the characteristics of such micro discharges.

The glow discharge device 11 may be a part of system 10 as illustrated in FIG. 1. The system may consist of the building blocks as outlined in FIGS. 1, 11, 12 and 13 (like FIG. 3). System 10 may have a sample gas filter 13 connected to an exhaust pipe 14 at an opening 15. Filter 13 may remove PM (particulate matter) and condensables from an exhaust sample 16 from exhaust 17. Then sample 16 may flow into the vicinity of glow discharge 18 situated in a glass pipe 33 and affect the emission of the discharge according to the composition of sample 16. Light 27 from discharge 18 may propagate through fibers 21, filters 22 and be converted to electrical signals by detectors 23. The electrical signals may go to amplifiers and microprocessor 24 to be processed into output signals indicating the composition of sample 16.

Glow discharge 18 may be about 10 to 500 microns in diameter. The discharge may be started and sustained with about a 100 to 400 volt AC/DC power supply in series with about a 1 to 15 Meg-ohm resistor 19, which generates the spectral band emissions shown in FIG. 7. Power supply 28 may be connected to metal electrode 31 via resistor 19 and to metal electrode 32. The glow discharge 18 may be started and maintained between electrodes 31 and 32 due to the presence of the voltage from the power supply 28. Electrodes 31 and 32 may be coated with an insulative material 46 such as, for example, MgO. Other materials may be used.

Optical fibers 21 may be optically connected to the glow discharge device 11 at optical interface or window 25 and be used with filters 22 for NO at 247.2 or 258.8±1.4 nm, a reference N₂ at 336.9 or 357.5±2 nm, other band pass filters for O₂, CH, C₂, CO, SO₂, as needed, and off-NO and N₂ at 251.2±2.5 and 362.3±4 nm, respectively. The optical filters 22 may be deposited at the flattened ends of the optical fibers 21, which would have narrow band pass half-width of about three nm (to match the ˜2.8 nm NO emission half bandwidth (HBW)) to 20 nm. Also shown in FIGS. 1, 11 and 12, are photo detectors 23 (Si-diode, Si-phototransistor, sensitized for UV) proximate to filters 22. Outputs of the photo detectors 23 may go to amplifiers and signal processor 24 which may output a referenced signal about NO, VOC, CO, SOₓ, or the like in the sample 16, with a ppm indication signal at output 35 of amplifiers and processor 24.

For operation, device 11 may be designed to force the micro discharge 18 to glow close to and impinge on the side of the observation fibers 21, as shown in FIG. 1. The mild discharge 18 sputter action may be intended to maintain a high level of optical transmission of the window 25 in FIG. 1, despite the known tendency of combustion exhaust gases to darken optical surfaces they come in contact with, in a short time. However, there may be cleaning action on the window 25 by the plasma of discharge 18. Also, the electrodes may be kept clean.

Significant elements of the system 10 in FIG. 1, and other systems described herein, may include optical fiber-cables 21 with deposited filters 22 at their ends with the other ends facing the glow discharge 18, and the PM filter or filters 13. Materials of these fiber and filters may include those that are low-cost, temperature resistant (not a high need due to the intermediate PM filter 13, which may cool sample gas temperatures) and of a high index, in order to minimize the angular sensitivity of the band-pass filters 22, which may be given by a few exemplary filters described in-terms of peak transmission wavelength, λₒ, vs. deviation angle, φ, of the incident beam from one parallel to the fiber axis:
λ_{φ}=λₒ(nₑ²−sin² φ)^{0.5}/nₑ.

This influence of the index, n, on λ_{φ} is illustrated by the data in the table of FIG. 8, for λₒ=250 nm and φ=10° and 20°. The highest index of the listed materials, i.e., sapphire with n=1.845 at 250 nm still may cause a shift by about 5 nm for φ=20°, but only about 1.5 nm for φ=10° (see FIGS. 2 and 14 for positioning the fiber 21 at some distance from window 25, so that φ≦10°), which may be one approach. Another one would be based on using a wider band-pass filter that covers all bands of NO with a half-width of 23 nm: λₒ=247.2±12 nm; the down-side of this approach is an approximately 5× loss in NO sensitivity and a greater probability for cross-sensitivity to other gases that might have spectral emissions in that same band. If this approach is chosen, the manufacturability, cost of the filter and its shifts due to angular and temperature variations may become less critical.

The concern about the influence of temperature is based on the fact that λₒ tends to shift to longer wavelength with increasing temperature (and vice versa) due to the thermal expansion of the coating materials, as suggested here.
λ_{T}=λₒ+α ΔT,
with α˜0.01−0.2 nm/deg. C.

This may shift λₒ by 10 nm for only a 100 degree C. rise in temperature and α=0.1 nm/deg. C., if the above information is correct. One would expect a value for α′˜10⁻⁶−10⁻⁵/deg. C. or α˜2·10⁻⁴−2·10⁻³ nm/deg. C.

It may be useful to calculate the maximum diameter, d, possible for a single-mode optical fiber, which also may have a more limited acceptance angle, which could keep the band-pass half-width of an associated interference filter small. For single mode optical fiber operation, the quantity V<2.405, where V=(πd/λ) {n(core)²−n(clad)²)}^{0.5}, so that the d<2.405·λ·{n(core)²−n(clad)²)}^{0.5}, which for an example based on sapphire (n=1.6) optical fibers, operation near 300 nm, and a Δn˜0.3 would require that d<673 nm. For single-mode fibers, the numerical aperture (=sine of largest acceptance angle, which is half-angle of the cone within which the light is totally internally reflected by the fiber core), NA=0.15 for single mode fiber and 0.3 for multi-mode fibers.
NA=sin(qₘₐₓ)=(n₁²−n₂²)^{0.5}.

Manufacturing costs may be low due to inexpensive parts and assembly as preliminarily noted here. The parts may include one grounded and one insulated wire in a tube 33 (glass, quartz, sapphire) to support the plasma in a spark-plug-like environmental package 44 as shown in FIG. 3, optical fibers 21 with deposited interference filters 22, two to four Si photo-diodes 23, a power supply 28 with a DC-to-DC converter (100-400V), an amplifier 24 for the photo-diodes 23, and a microprocessor 24 for signal processing and logic functions, a PM filter 13 and sample gas flow channels. Also, automated assembly and calibration may be implemented to reduce costs. A very little scrap would be expected from the making of the present micro-plasma sensor system 10.

NOₓ sensing via MDD may have been done by others, with noble gas purge in one micro channel leading to the MDD, but has not been done without such purge, directing only the sample gas to the MDD. Features of the sensing system in FIG. 1 include: operating the MDD without noble purge gas; using MDD for window cleaning and for maintaining electrode isolation in an MDD detector application; observing no spectral emissions in the IR; designing a co-planar MDD as source another MDD as detector; and co-locating a spectral-emissive and, for example, a soot sensor in one package.

There may be self-cleaning of the optical surface 33 on the MDD side and facing the optical fiber, i.e., window 25 of FIGS. 1, 2, 4 and 6. No noble gas purge cleaning is needed. The sensor system 10 may include use of plasma discharge device 11 for exhaust gas composition measurements, but without noble-gas purge; use of the plasma discharge 18 to keep the observation window clean, by plasma-etching away any combustion-product deposits such as condensable tars and carbon-soot; use of the same plasma discharge to maintain the required electrical insulation of the non-grounded micro-discharge electrode (see magnified view of one example electrode tip in FIG. 2); use of a plasma discharge to maintain the required electrical insulation of the non-grounded electrode by additional periodic power-cleaning cycles, which may or may not cause a pause in the measurement and the self-check cycle; use of an associated PM filter 13 to cool and clean the sample gases after soot sensing but before spectral MDD sensing, in order to minimize temperature-induced wavelength shifts in the bandpass filter; use of smart positioning between the end of the optical fiber and the photodiode to detect only optical fiber light components of small angles, as required by the chosen bandpass filter width; and use of the same or a similar glow discharge 18 to maintain cleanliness and (more importantly) the required electrical isolation of the soot-sensor electrodes (not shown FIGS. 1-3).

Additional design features related to quasi state-of-the-art PM filters may include mechanisms for overcoming concerns about water condensation (removal or made harmless via sensor heating), and packaging the soot sensor electrode into this same housing to reduce cost, total bulkiness and plasma-cleaning synergies.

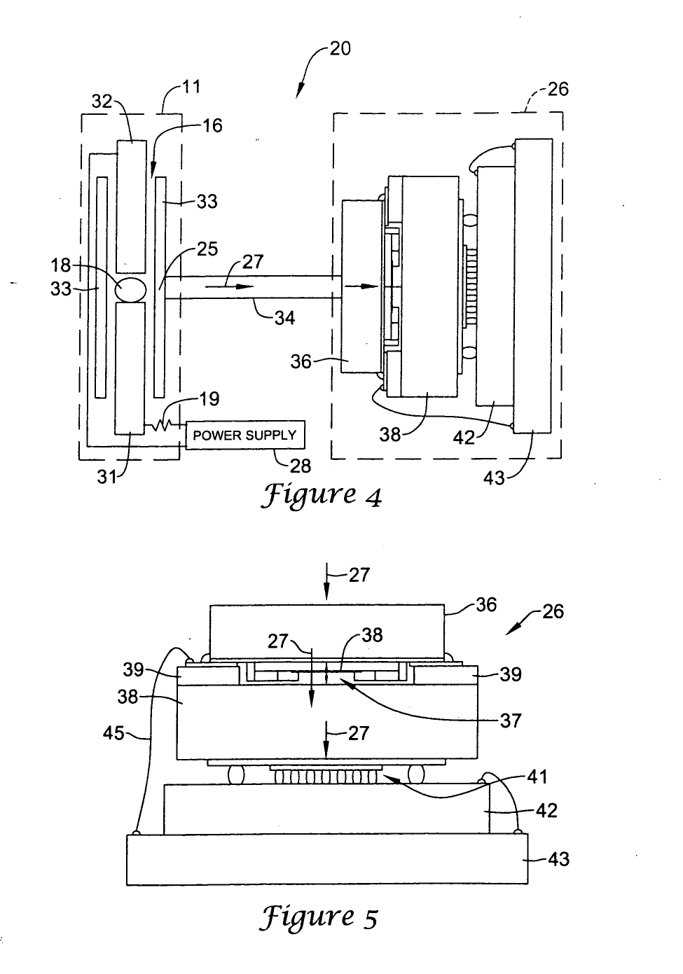

Another implementation of glow discharge device 11 is system 20 shown in FIG. 4. A scanning Fabry-Perot filter 26, shown with more detail in FIG. 5, may be adapted to the band pass and wavelength range desired for the desired application. A PM filtered gas 16 may enter the glow discharge device 11 and enter the vicinity of the glow discharge 18. Discharge 18 may be enclosed in a glass capillary or pipe 33. The discharge 18 may be started and sustained by a voltage of about 100 to 400 volts from power supply 28 connected to electrodes 31 and 32 from which the discharge emanates. A light pipe 34 or other optical conveyance mechanism may be optically connected to the glass pipe 33 at a window 25 to carry the light 27 of the discharge to a non-dispersive, Fabry-Perot, narrow band-pass, scanning filter 26. Filter 26 may provide a spectral analysis of the light 27.

Filter 26 may be a Fabry-Perot (FP) based MEMS spectrometer for MDD emission analysis. Light pipe 34 may be optically coupled to a Pyrex or quartz window 36 of filter 26. Window 36 may be a UV blocking filter. As shown in FIG. 5, light 27 may propagate through window 36 into a FP cavity having about a 5 mil (25 micron) high cavity 37 with an etalon 38 that may move up or down to adjust cavity 37 to a particular frequency of interest to be passed through or filtered out. The movement of etalon 38 may be effected with a control signal line 45. This adjustment may determine the wavelength of light 27 to be passed or blocked. Cavity 37 may be formed with a sapphire base 38 and window 36 with an environmental hermetic seal 39 formed around the perimeter of cavity 37 to provide space in the cavity and a seal between window 36 and sapphire base 38 to seal the cavity from its environment. The portion of light 27 that passes through cavity 37 may be sensed by an array of detectors 41. The detectors 41 may be in a form of a linear or another kind of array, and be composed of AlGaN/GaN or other appropriate or workable material. Detectors 41 may convert the light signals 27 into electrical signals that are input into a readout integrated circuit 42. Circuit 42 may have a processor to analyze the signals to provide information about the sample gas 16. A package 43 may be utilized overall to enclose at least a portion of filter 26. The output of circuit 42 may provide a spectral analysis of light 27. This analysis may imply the composition of the sampled gas 16 passing through the glow discharge 18.

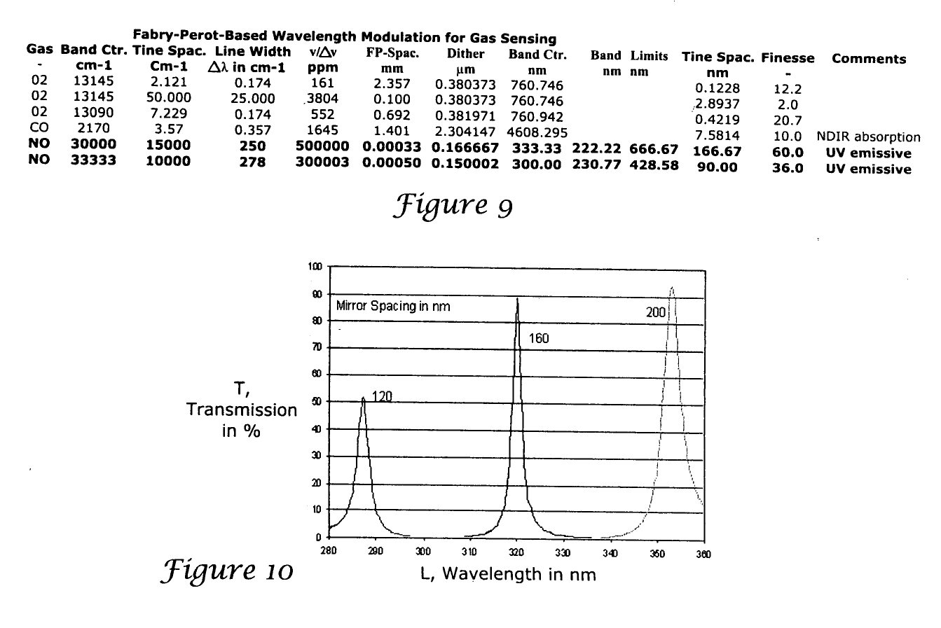

During operation of filter 26, one may envision that only one (and not many in parallel) tine (=transmission peak of the Fabry-Perot comb-filter) of about 1 nm to 3 nm half width does the scanning, while the others may be designed to be outside of the scanning area. The table in FIG. 9 shows parameters of FP-based wavelength modulation for gas sensing. It gives some examples of the FP-filter design parameters needed to accomplish this application of the MMD as well as for other applications (CO and O₂ sensing). The parameters shown in FIG. 9 may include the gas sensed, band center, tine spacing, line width, ν/Δν, FP spacing, dither, band limits and finesse, among other parameters.

As the FP-spacing layer 38 of cavity 37 is dithered by a given amount, the Δλ line-width band-pass may scan around the band center by ± the tine spacing in cm⁻¹ or nm, or between the shown band limits in nm. The computed Fabry-Perot band width and spectral position (and including the response of the AlGaN detector array) for the last row in the table in FIG. 9 may be shown in FIG. 10 for the minimum, center and maximum wavelength position, respectively, with the corresponding etalon mirror spacing. FIG. 10 shows percentage of transmission versus wavelength for a wavelength scan of a MEMS FP filter. The wavelength position may be limited in the computed example in FIG. 10 by the available wavelength sensitivity range of the AlGaN detectors, which is about 290 to 360 nm.

Features of system 20 in FIG. 4 may be taken as exemplary emission bands for which the scanning FP-filter and detector 26 would need to achieve the following measurement performance (λ and ±Δλ/2): with NO at 247.2 or 258.8±1.4 nm, reference N₂ at 336.9 or 357.5±2 nm, and off-NO and N₂ at and 251.2±2.5 and 362.3±4 nm, respectively.

One may consider the known influence of f-number on achievable FP-filter 26 finesse, which may be even more constraining here. However, one may design the FP-filter 26 to be less sensitive to temperature-induced drift of the wavelength band-pass, but also limited by the temperature range rating of the discharge device 11.

The sensor system 20 may be based on the following: plasma micro discharge device (MDD) for gas sensing via spectral emission analysis of unknown gas mixture samples, using non-dispersive (Fabry-Perot-based) spectral analysis (rather than a dispersive spectrometric analysis) or interference filters; the Fabry-Perot (FP) wavelength scan performed via a MEMS-based FP-filter design; new use of the above assembly (of MDD and FP-based spectral filter) as high speed gas chromatography peak (GC) analyzer, and independently, as stand alone gas sensor for NO, O₂, SO₂, . . . in one unit; new use of above assembly (MDD+FP+GC), whereby the GC is a μGC or a μGC-μGC or a μGC-μGC-MDD gas mixture analyzer, of low probability for false positives, P_{fp}; and a design of the MDD in which the discharge self-cleans the window 25 and operates without a noble gas purge.

Successful implementation of systems 10 and 20 may enable the achievement of low false positive probabilities when using this discharge device 11 and detector as part of a GC-CG-MDD micro-analyzer, as represented by PHASED.

The sensing systems 10 and 20 may offer the following advantages over previously proposed or offered exhaust gas composition sensing systems. They are more compact, rugged and lower cost than chemiluminescence-based sensor systems. They are more stable than metal-oxide or catalyst-based and conventional optical sensor systems. They are less energy consuming than ZrO₂-based NO and O₂ sensor systems and more temperature change tolerant than other ZrO₂—NO/O₂ sensor systems. They are more manufacturable than multi-layer ZrO₂, metal oxide or catalyst based sensor systems. They are compatible and easy to integrate with a soot sensor system.

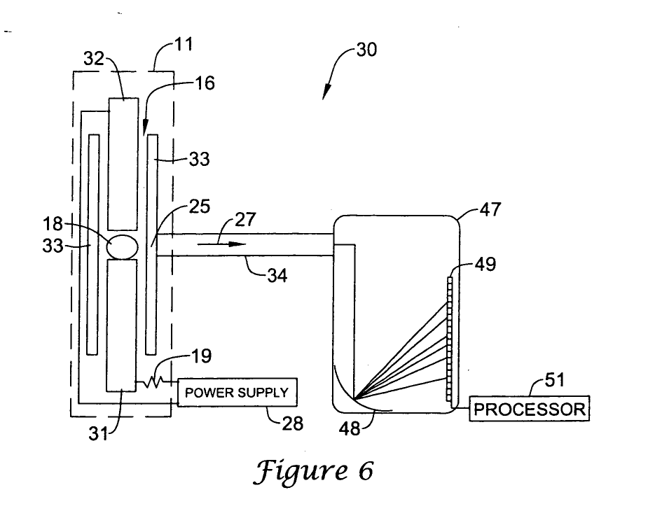

System 30 of FIG. 6 may have a discharge gap device 11, like that of systems 10 and 20, except that light 27 may be conveyed via a light pipe 34 to a dispersive spectrometer 47 for analysis of the emission of the discharge 18 to reveal information about the sample gas 16. Light 27 may be conveyed to an optical grating 48 for reflection of various wavelengths of light 27 to various pixels, respectively, of a CCD light detecting array 49. Electrical signals from array 49 may go to a processor 51 for analysis and interpretation.

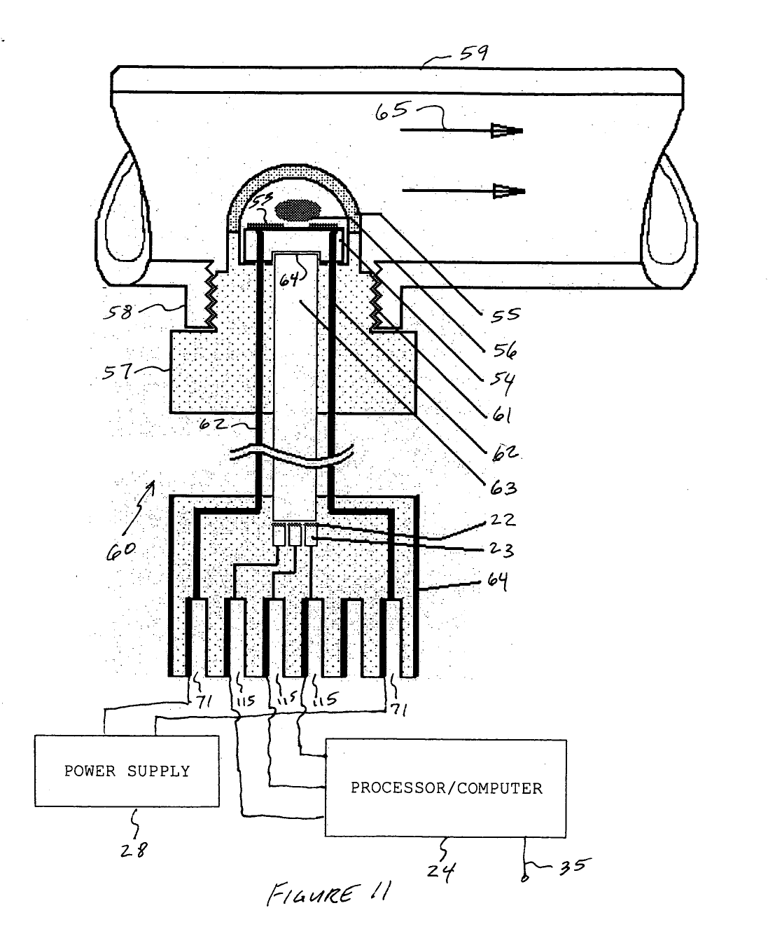

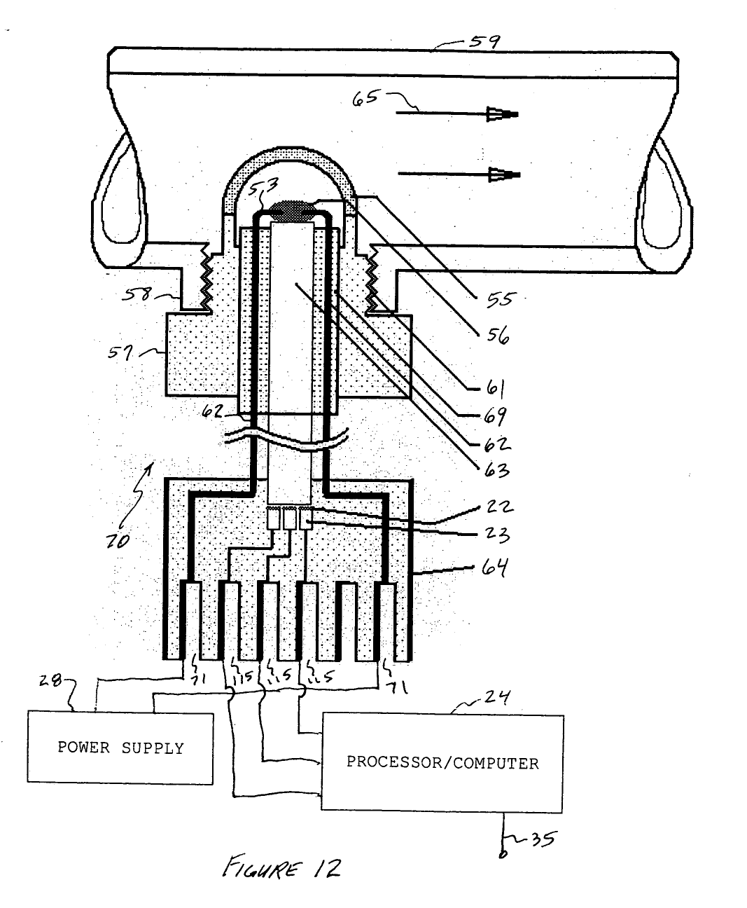

One sensor system is depicted in FIGS. 11, 12, 13, 14 and 14a, while other systems are shown in FIGS. 1, 2 and 6. The MDD (micro discharge device) 60 of FIG. 11 may generate an optical emission 56 that is characteristic of the gaseous environment around the electrodes 53 supported by a ˜2×2 mm silica chip, as protected from particulates of exhaust gases 65 by a screen or stainless frit 55 which may be regarded as an enclosure or housing for at least partially containing the electrodes and the light waveguide or waveguides. Exhaust gases 65 may be turbulent and reach temperatures up to 1100 degrees C. (2012 degrees F.). MDD 60 may be housed in a spark plug type of package or housing 57 like that shown in FIG. 13. The housing 57 may be threaded to be in a fitting 58 having, for example, M14 threads 61. Or the fitting 58 may be formed or welded to an exhaust pipe 59 or other fixture that may have a fluid to be tested. Housing or package 57 may have a hex fitting like a nut or bolt so that the housing and package may be screwed in or out with a tool such as a wrench.

Light may be conveyed from discharge 56 through fiber 63 to optical filters 22. Fiber 63 may be a silica fiber having an outside diameter of about 20-200 microns. The filters 22 may have a delta wavelength of about 2-5 nm. The filtered light may proceed on to be detected by photo diodes, phototransistors or generically “light detectors” 23, on a one filter to detector basis, respectively. Electrical conductors may connect the detectors 23 to terminals 115 of connector 64. Terminals 115 may be connected to a processor 24 (as shown in FIG. 1, though not shown in FIGS. 11 and 12).

A mode of failure could be via contact problems between the electrical leads 62 fed through or around the silica chip 54 and those embedded in the spark plug package 57. Alternatively, there may be a simple spark plug housing package 57 which includes a pair of self-supporting discharge electrodes 53, or the ends of leads 62 which may be electrodes, a discharge 56 that maintains the optical fiber 63 inlet surface 64 clean, and without a MDD silica chip 54. The electrodes may be kept clean also. This cleaning of surface 64 and electrodes may occur without the presence of a noble gas. The leads 62 may be extended from connector 64 to electrodes 53. The length of the leads 62 and waveguide 63 may be about 10 to 40 cm.

To avoid contact problems with the electrodes 53 and leads 62, FIG. 12 shows another version of the sensor package, where the silica chip 54 may be eliminated, with the electrical leads 62 coming through the spark plug housing 57 and extending into the exhaust gas side of the sensor. The leads 62 may be strong enough to hold their position and shape without the need of the silica chip 54 to support them. There may be an alumina insulator 69 about the leads 62 and waveguide 63 within a package, housing or structure 57. The separate discharge electrodes 53 which were fashioned out of deposited thin-film metal material may be dispensed with in favor of the ends of leads 62, the latter of which may be regarded as substituting electrodes 53. The shape and space between the latter electrodes may be formed via mechanical cutting, shaping and bending, to result in the typical electrode shape and spacing of 10 to 30 microns, not unlike self-supporting spark-plug electrodes. There may be savings in eliminating the cost of the fabricating the silica chip 54, its feed-throughs for leads 62, the deposition of the electrodes (ends of leads 62) with contact metals, chip dicing, and the positioning and bonding to the spark-plug-like housing 57 feed-throughs. The ends of the leads may be regarded as electrodes 53 or 62.

There may be an elimination of potential performance problems caused by less than the ideal and clean optical interface between the silica chip 54 and the optical fiber 63, and a reduction of the losses in transmission through the interface between the silica chip 54 and fiber 63.

During operation, successful system designs may cause the micro discharge 56 to glow close to and impinge on the side of the observation optical surfaces, such as those of the silica fiber 63, chip and/or window. The mild discharge sputter action may be intended to maintain a high level of optical transmission of the optical transmission surface, despite the known tendency of combustion exhaust gases to darken optical surfaces they come in contact with, in a short time, due to a deposition of tarry and soot-containing materials. Such is the cleaning action of discharge plasmas. Excessive discharge action may etch the material of surfaces close to the glow discharge, while insufficient action (i.e., power) may create deposits.

A capillary electrode discharge (CED) approach may be used to generate atmospheric plasmas, and surface cleaning such as the removal of organic material on glass substrates. Helium or hydrogen (He or H₂) may be used as an ignition and discharge gas and oxygen (O₂) be added as a reactive gas. Low frequency AC power supply with a sine wave voltage (20 kHz to 20 GHz) may be used to generate plasmas under atmospheric pressure. The electrodes may be composed of a 10 micron thick capillary dielectric and have a diameter of about 300 microns. He/O₂ plasmas generated in the space of a few mm between the capillary electrode and the substrate (ground) may be uniform and very stable. The optical emission spectroscopy and the I-V characteristic of the discharges may be used to characterize the capillary electrode discharges. A removal of organic materials such as photoresist, in addition to He/O₂ plasmas, the effects of other gases like those of He additive gases such as CF₄, Ar, and N₂, may be implemented. Cleaning rate of organic material on glass higher than 100 Å/min may be observed after exposure to He/O₂ plasmas. There may be some effects of various gas mixtures in addition to those of He/O₂ on the cleaning rate of organic material and surface chemical composition of the remaining residue as might be measured by x-ray photoelectron spectroscopy.

FIG. 14 shows a sensor system 80 having a housing or enclosure 66 with a particle suppression structure 67 having louvers, a sample gas input/output, and a swirl and cyclone separator. Housing or enclosure 66 may be regarded as containing at least partially the electrodes and the light waveguide or waveguides. Structure 67 may have impactor plates 68 for aiding separation of particles of fluid 65. The flow of exhaust 65 through structure 67 may be induced by head pressure and venturi action, assisted by components of enclosure 66, including a 0.3 mm opening at the top of the enclosure or structure inserted in the flow of the fluid or exhaust gas 65. Also, fluid or exhaust 65 may be rather turbulent in the pipe or conveyance 59, and structure 67 may provide a way of sampling exhaust 65 for the micro discharge 56 without disrupting the latter for an accurate reading with sensor system 80. Electrodes 53 may provide the basis for the micro discharge 56. The reaction of the discharge 56 to the fluid 65 being sensed may be optically transmitted by optical fiber 63 to a light detector for conversion to electrical signals. The signals might be digitized for computer processing and analyses of the fluid. The light conveyed from the discharge 56 may be IR, visible and/or UV. Leads or electrodes 62 and fiber 63 may be contained and structurally supported within housing 57 having a ceramic insulator 69. Electrodes 62 may be attached to connector pins 71 which may have a 0.3 mm dimension. The discharge 56 may keep the electrodes and the input surface of waveguide clean without the need of noble gas purging. The filters, detectors, power supply and processor associated with system 80 may similar to that of systems 60 and 70.

FIG. 14a shows a sensor 81 having the same kind of structural and electrical parts as sensor system 80, except that the former has a housing that is somewhat different. Structure 82 may have an input of fluid 65 from the sides and a procession of the fluid through a number of impactor plates and into the micro discharge 56 area, and an exit out through the end or top of housing or structure 82. On the other hand, structure 82 may be designed to have both an input and output of fluid at the top of it. Systems 60, 70, 80 and 81 may be used to sense other fluids besides exhaust gases 65.

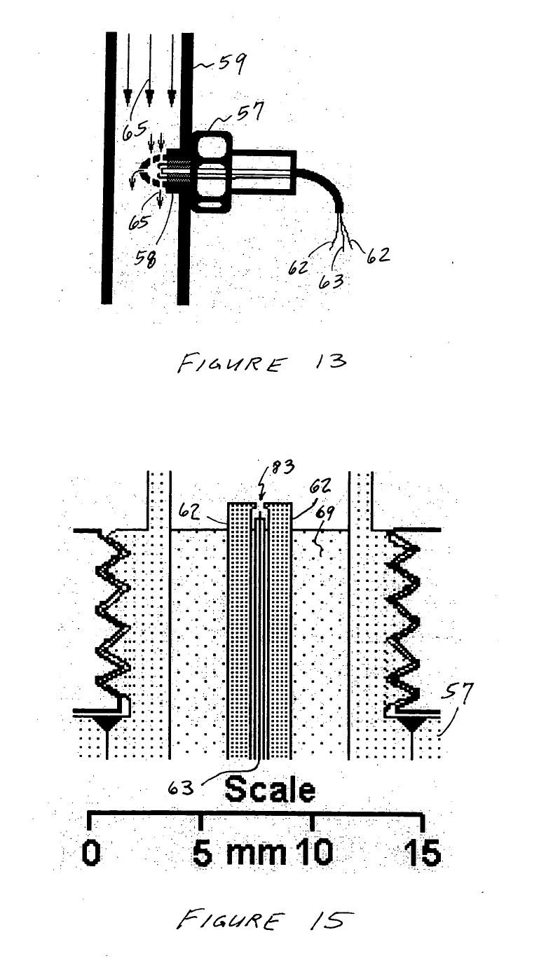

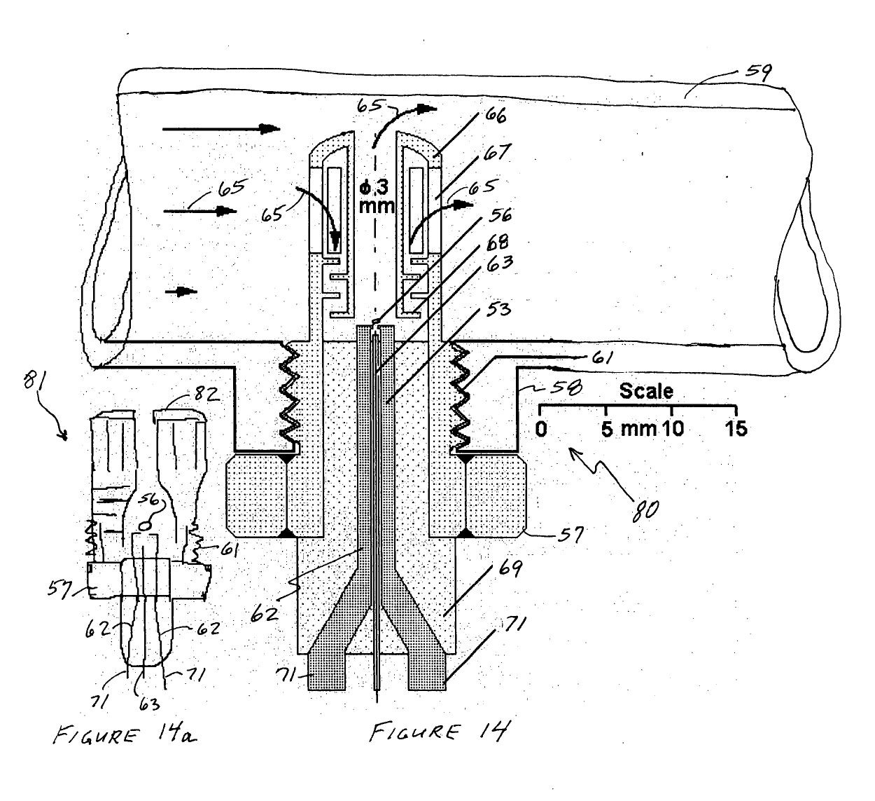

There may be ruggedized MDD sensor systems. FIGS. 16, 17, 18a and 18b show sensor configurations that expand on those in FIGS. 14 and 14a. The preferred range of the electrode 62 gap 83 for atmospheric MDDs may be 30 to 70 microns. FIG. 15 details the electrode gap 83 area shown in FIG. 14. The shape of the two electrodes 62 at the discharge location may enable the spacing between the two electrodes to be within a desirable range, after being kept apart by the thick optical fiber 63 cladding. However, a “hook” at the electrode 62 tips may add unacceptable cost during manufacture, and the cavity may plug up with deposits during use in a car exhaust environment.

FIG. 16 shows an arrangement 113 that may avoid the plugging and spacing problem by using a tubular bottom electrode 84 and a (grounded) top electrode 85, with a tip 86, which lines up with the centered optical fiber 87, having a thin (≦λ/2) cladding 88. The fiber with the cladding may have a diameter 116 of about 70 microns. The risk of 30 to 70 micron discharge gap misalignment may be high and possibly costly to overcome. The gas discharge area may be represented by the two elliptical, shaded areas 89.

FIG. 17 shows an arrangement 114 having a qualitative (not to-scale) side view of a tube-shaped optical fiber 91, where the discharge (elliptical shaded areas 92 shown to represent the cross section of a ring-shaped or annular micro discharge) occurs between the center 93 and outer 94 electrodes and over the top rim of the tube-“fiber”. The tube-fiber 91 may be replaced with a number of optical fibers adjacent to each other parallel to one another to the electrodes. The overall diameter of the device 114 may be about 3 mm. The center electrode 93 may have a diameter of about o.5 mm. The tube-fiber or optical fibers 91 may have an outside diameter of about 0.6 mm.

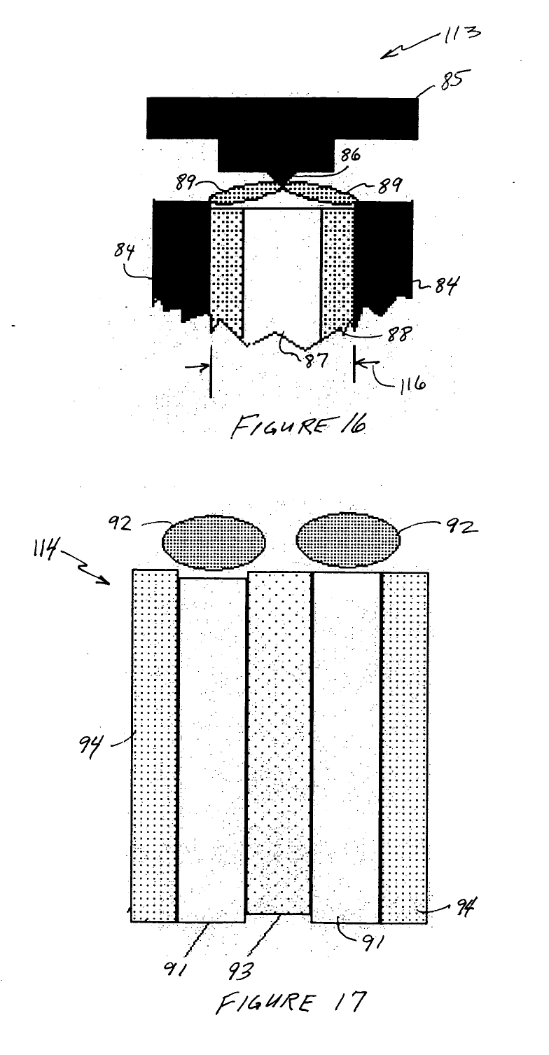

FIGS. 18a and 18b show arrangements 111 and 112, respectively, with a single 40 to 70 micron diameter 117 optical fiber 95 with cladding of a small thickness, and four of such fibers 95 having positions and being fastened between two larger-diameter metal electrodes 96 and 97 of about 300 to 500 microns (0.3 to 0.5 mm) in diameter. Both electrodes 96 and 97 may be anchored within the same ceramic block 69 as shown in FIG. 14. The discharge light 56 may be aligned with the optical fibers 95, and the assembly may be manufactured with relative ease. The use of separate fibers 95, besides lending mechanical flexibility, also enables design flexibility on how to separate different wavelength channels (via band-pass filters 22 of FIG. 1 or a dispersive element).

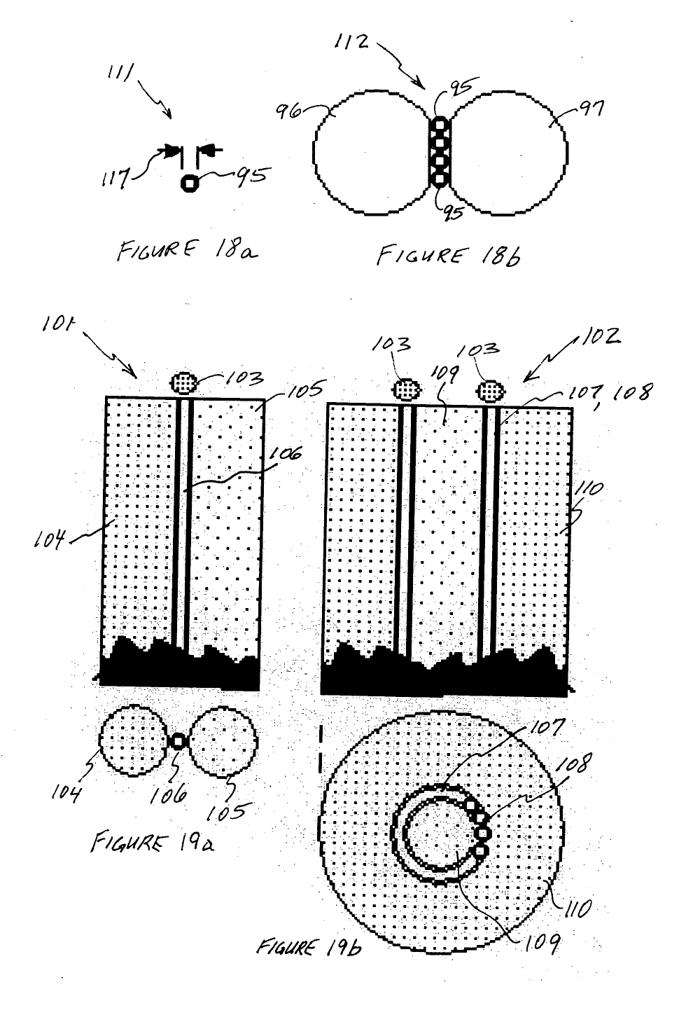

FIGS. 19a and 19b represent two versions 101 and 102 of the sensor system related to FIGS. 17, 18a and 18b, with respect to capturing the discharge light 103, ease of manufacture (gap adjustment and stability, despite temperature fluctuations, via a common ceramic anchoring block) and design flexibility. Version 101 shows electrodes 104 and 105 with a fiber 106 between the electrodes 104 and 105 to convey light from discharge 103 of the assembly 101. One may note that the tube-shaped optical fiber 107 in FIG. 19b may be broken into or replaced with a number (10 to 20) of individual fibers 108 that are positioned along a circular order or path about the central electrode 109. A circular discharge 103 may be initiated between the center electrode 109 and circumferential electrode 110. The circular fiber arrangement 107, 108 may convey the light from the discharge 103 of the assembly or arrangement 102. Arrangement 102 may bear much resemblance to arrangement 114 of FIG. 17, except that the tubular fiber 91 of arrangement 114 may be in lieu of a plurality of fibers 108 in arrangement 102.

The arrangements 112 and 102 shown in FIGS. 18b and 19b, respectively, appear to provide a significant area for discharge 92 and 103, and optical fiber 91 and 107, 108, for conveying light of the discharge from the arrangements to appropriate optical and electrical mechanisms for signal processing and analyses.

Although the invention has been described with respect to at least one illustrative embodiment, many variations and modifications will become apparent to those skilled in the art upon reading the present specification. It is therefore the intention that the appended claims be interpreted as broadly as possible in view of the prior art to include all such variations and modifications.

1. A sensor system comprising:
a first electrode;
a second electrode proximate to the first electrode to form a gap between the first and second electrodes;
a light waveguide having a first end proximate to the gap; and
wherein the waveguide is situated between the first and second electrodes.

2. The system of claim 1, wherein the waveguide is at least one optical fiber.

3. The system of claim 2, wherein the waveguide is a plurality of optical fibers.

4. The system of claim 1, wherein:
the waveguide is a layer formed around the first electrode; and
the second electrode is a layer formed around the waveguide.

5. The system of claim 1, wherein:
the waveguide is a plurality of optical fibers adjacent to one another and situated like a layer around the first electrode; and
the second electrode is a layer formed around the waveguide.

6. The system of claim 5, wherein the first and second electrodes form a concentric gap.

7. The system of claim 6, wherein the concentric gap is an annular micro discharge gap.

8. The system of claim 7, wherein the discharge gap can provide an emissive glow discharge plasma at a temperature up to 1100 degrees C.

9. The system of claim 1, wherein the sensor system is structured to sense a fluid of a group consisting of NOₓ, O₂, NH₃, SOₓ, COₓ and VOC.

10. The system of claim 1, further comprising:
an enclosure encompassing at least partially the first and second electrodes; and
wherein the enclosure comprises an input and an output.

11. The system of claim 10, wherein the enclosure comprises at least one baffle.

12. The system of claim 10, wherein the enclosure is a stainless steel frit.

13. The system of claim 1, further comprising:
a spark-plug-like housing; and
wherein the housing at least partially contains the first and second electrodes and the light waveguide.

14. The system of claim 13, wherein the first and second electrodes are self-supporting electrodes.

15. The system of claim 14, wherein the housing comprises an insulator holding the first and second electrodes.

16. The system of claim 10, wherein the enclosure comprises a particle suppresser.

17. The system of claim 2, wherein the gap is an electrical discharge gap.

18. The system of claim 17, wherein the first electrode is susceptible to soot build-up and is kept clean by the electrical discharge gap.

19. The system of claim 18, the first electrode is kept clean in absence of a noble gas.

20. The system of claim 1, wherein the gap can generate a discharge and keep clean an optical surface of the first end of the light waveguide.

21. The system of claim 20, wherein the optical surface of the first end of the light waveguide is kept clean in absence of a noble gas.

22. The system of claim 17, further comprising at least one filter proximate to a second end of the light waveguide.

23. The system of claim 22, wherein the at least one filter is a bandpass filter for a wavelength band.

24. The system of claim 23, further comprising a light intensity indicator connected to the filter.

25. The system of claim 24, further comprising an enclosure encompassing at least partially the first and second electrodes.

26. The system of claim 25, further comprising a particulate matter filter connected to the enclosure.

27. The system of claim 26, further comprising a spark-plug-like package wherein the package encloses at least partially the particulate matter filter, the first and second electrodes, and the first end of the light waveguide.

28. The system of claim 27, wherein the spark-plug-like package is connected to an exhaust system.

29. A sensor system comprising:
a light waveguide;
a first electrode formed concentrically around the light waveguide; and
a second electrode proximate to an end of the light waveguide and forming a gap with a concentric end of the first electrode.

30. The system of claim 29, wherein the light waveguide is an optical fiber.

31. The system of claim 30, wherein the optical fiber comprises:
a light transmitting core; and
a cladding formed concentrically around the core.

32. The system of claim 31, wherein the gap is an annular electrical discharge gap.
